(19) United States
(12) Patent Application Publication
(10) Pub. No.: US 2012/0210531 A1
(43) Pub. Date: Aug. 23, 2012

(54) Golf Towel With Dry and Wet Sections

(76) Inventor: SUNG KUK, LOS ANGELES, CA (US)

(21) Appl. No.: 13/033,572

(22) Filed: Feb. 23, 2011

(51) Int. Cl. B08B 1/00; B31B 1/26

(52) U.S. Cl. 15/210.1; 493/243

(57) ABSTRACT

A golf towel and various methods of folding thereof for keeping at least one golf ball wet is disclosed. The golf towel comprises a wet surface and a dry surface, the wet surface and the dry surface being attached using a water impervious layer. The golf towel can be folded in a number of ways defining at least one water retaining pocket like structure. The golf towel being folded brings forth a pressure along the folded edge. As the number of folding in the golf towel increases, the pressure exerted at the folded edge will also be greater thereby minimizing the amount of water evaporating from the wet surface. The water impervious layer interposed between the wet surface and the dry surfaces prevents the transferring of moisture from the wet surface to the dry surface.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to golf towels, and more particularly to various methods of folding a golf towel to form at least one water retaining pocket like structure for effectively cleaning golf balls and to keep the golf ball wet.

### DISCUSSION OF RELATED ART

Golf is a sport that continues to increase in popularity. While playing the game, a golfer will typically encounter residual dirt, grass and other material on the golf ball, club faces and/or his hands as he traverses the golf course. Golfers often spend time on the golf course when the weather or playing conditions may not be ideal for the game, like on a hot, humid day, or in the early morning when there is still dew on the ground, or even on a rainy day when the grass and ground are still wet. These are the times when a golf towel becomes a necessity for wiping your hands or for cleaning the golf club heads, golf balls, or golf handles from perspiration, dampness, dirt and grass.

One prior art described in U.S. Patent Application No. 2010007560 published to Cabullo on Apr. 1, 2010 defines a golf towel with a pocket and embedded in the pocket a reservoir for dispensing cleaning liquid is described. The towel design and reservoir system enables controlled release of the liquid only when required for cleaning. The system allows temporal control for release of the liquid, control of the amount of liquid released, and, control of the location on the towel to which the liquid is dispensed. However, the golf towel described in the above invention does not provide a dry surface for cleaning.

Another prior art described in U.S. Pat. No. 6,858,281 issued to Kim on Feb. 22, 2005 describes a golf towel having an inner layer for containing water in its pore structure and an outer layer releasing the water to the air. A novel golf towel, retaining water over four hours under an average weather for golfing, is comprised of an outer layer of Terry cloth made of a composite texture of including but not limited to, cotton, polyester and polyimide, an inner layer of porous hydrophilic polymer and a grommet for a holding means. However, the golf towel described in the above invention provides water retaining capability only for four hours.

Another prior art described in U.S. Pat. No. 5,813,080 issued to Hendren on Sep. 29, 1998 an improved hand-held towel structure suitable for cleaning and drying athletic apparatus and other implements in wet weather is described. The towel structure includes an outer layer of towel material having a first predetermined absorbency which is separated from an inner layer of wiping material having a second predetermined absorbency by a film layer that substantially inhibits transfer of water from the towel material to the wiping material. The improved towel structure is arranged such that the outer layer of towel material may be utilized for wiping and cleaning the athletic equipment or other implements, while the film layer inhibits transfer of any soil or water to the inner wiping layer. The structure substantially defines an inner pocket open at the bottom in which the athletic equipment or other implements can be inserted for further wiping and drying. Various structures for retaining the elements of the towel structure in position relative to each other are described. However, the number of pockets in the golf towel described in the above invention is limited to one.

Therefore, there is a need for a golf towel that can perform the function of making the ball wet as well as drying the ball as the situation demands. Further, the towel would be capable of retaining the water content. Also different methods of folding the golf towel would add additional benefits of using the towel in different situations thereby providing a better visual appearance for the golf towel. The present invention accomplishes these objectives.

### SUMMARY OF THE INVENTION

The present invention is a golf towel and various methods of folding the golf towel for keeping at least one golf ball wet. The golf towel comprises a wet surface and a dry surface, the wet surface and the dry surface being attached by means of plurality of eyelets and the connecting means using a water impervious layer. The golf towel can be folded in a number of ways defining at least one water retaining pocket like structure, the golf towel being folded bring forth a pressure along at least one folded edge to reduce the amount of water evaporating from the wet surface. The water impervious layer interposed between the wet surface and the dry surface prevents transferring of moisture from the wet surface to the dry surface. The golf towel is narrower from a middle portion of the wet surface to an edge of the golf towel. The golf towel may contain a plurality of eyelets that assists to secure the golf towel when folded together and to hang the golf towel using a connecting means.

The present invention includes various methods of folding the golf towel thereby defining at least one water retaining pocket like structure. Preferably, the wet surface of the golf towel is folded in at least one method such as a double square type folding method, a rectangle type folding method, a double triangle type folding method, a single triangle type folding method, an inner double square type folding method, an inner double triangle type folding method, and an inner double rectangle type folding method to form at least one water retaining pocket like structure. The golf ball to be kept wet is placed in the water retaining pocket like structure and the ball is cleaned by water adhered inside the pocket like structure of the golf towel. The ball is taken out of the wet surface and the moisture content is completely removed from the ball by wiping the ball with the dry surface of the golf towel.

Other features and advantages of the present invention will become apparent from the following more detailed description, taken in conjunction with the accompanying drawings, which illustrate, by way of example, the principles of the invention.

### DESCRIPTION OF THE DRAWINGS

FIGS. 1a to 1c show a perspective view of the invention, illustrating a golf towel;

FIGS. 2a to 2d show a golf towel, illustrating the sequence of folding involved in the square type folding method;

FIGS. 3a to 3d show a golf towel, illustrating the sequence of folding involved in the rectangle type folding method;

FIGS. 4a to 4e show a golf towel, illustrating the sequence of folding involved in the double triangle folding method;

FIGS. 5a to 5e show a golf towel, illustrating the sequence of folding involved in the single triangle folding method;

FIGS. 6a to 6d show a golf towel, illustrating the sequence of folding involved in the inner double square type folding method; and

FIGS. 7a to 7e show a golf towel, illustrating the sequence of folding involved in the is inner double triangle type folding method.

FIGS. 8a to 8d show a golf towel, illustrating the sequence of folding involved in the inner double rectangle type folding method;

### DETAILED DESCRIPTION OF THE PREFERRED EMBODIMENT

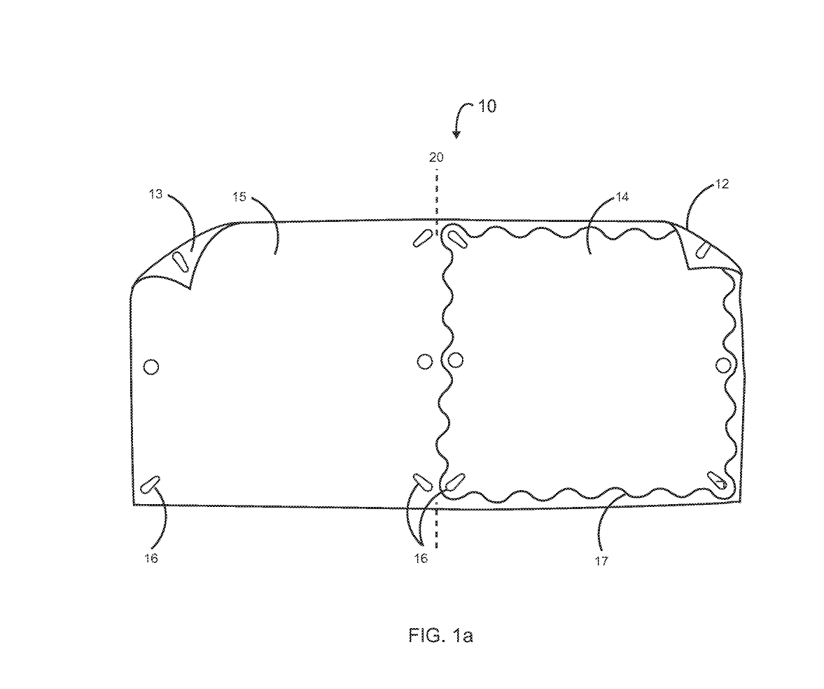

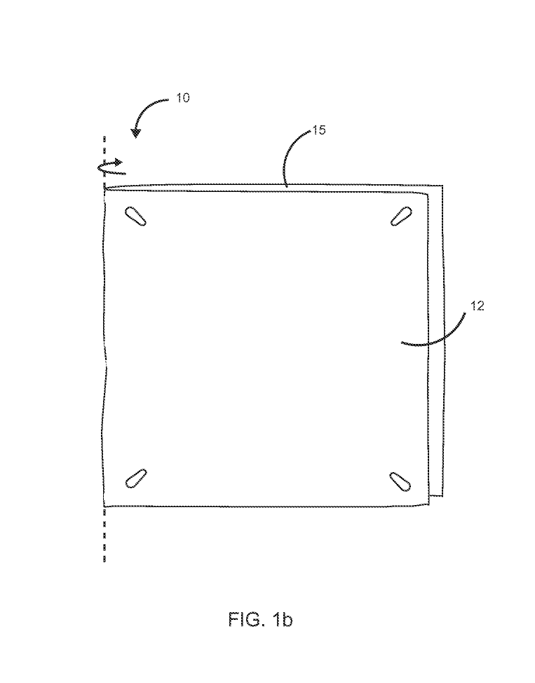

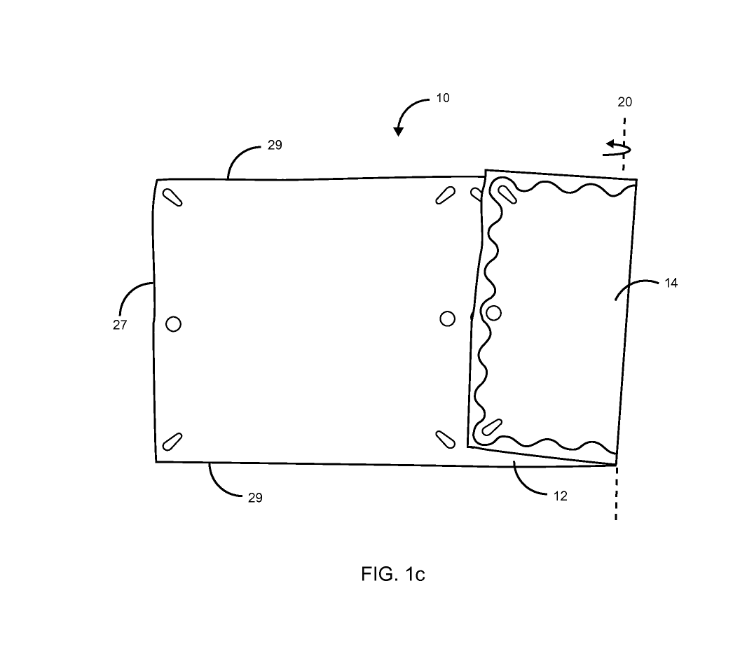

FIG. 1a shows a perspective view of a golf towel 10 for keeping at least one golf ball (not shown) wet. The golf towel 10 comprises with a wet surface 12, a dry surface 13, a dry surface 14 attached with the water impervious layer 17, and dry surface 15. The area of the wet surface 12 is at the right side of the central vertical axis 20 of the rear part. The area of the dry surface 13 is at the left side of the central vertical axis 20 of the rear part. The area of the dry surface 14 is at the right side of the central vertical axis 20 of the forepart. The area of the dry section 15 is at the left side of the central vertical axis 20 of the forepart. The water impervious layer may be made of polyurethane. The golf towel 10 can be folded in a number of ways defining at least one water retaining pocket like structure (not shown). A plurality of eyelets 16 present in the golf towel 10 assists to secure the golf towel 10 when folded together and to hang the golf towel 10 by using a connecting means (not shown). FIG. 1b shows the water impervious layer 17 (not shown), being attached to the dry surface 14 (not shown), interposed among the wet surface 12, the dry surface 13 (not shown), the dry surface 14 (not shown) and the dry surfaces 15 prevents transferring of moisture from the wet surface 12 to the dry surfaces. FIG. 1c shows most of the wet surface 12 being closed up by folding the golf towel 10 is along the right side middle vertical axis 21. The area of folded wet surface 12 is smaller for moisture to evaporate than the area of unfolded wet surface of 12. The dry surface 14 is the outside surface 14 and forms forepart. The golf towel 10 may be made of microfiber. The golf towel 10 is narrower along the edge of 29 starting from a point of the central vertical axis 21 crosses to the vertical edge 27.

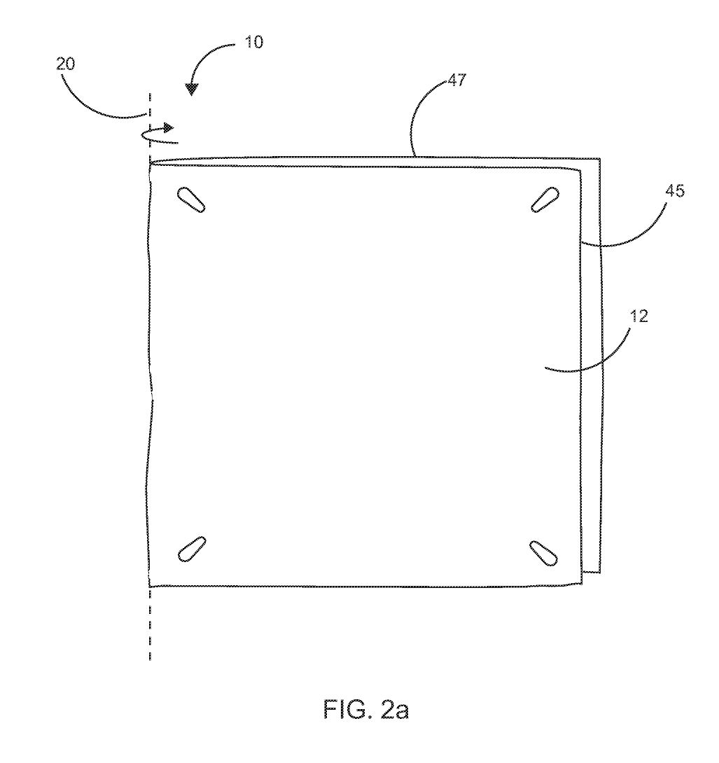

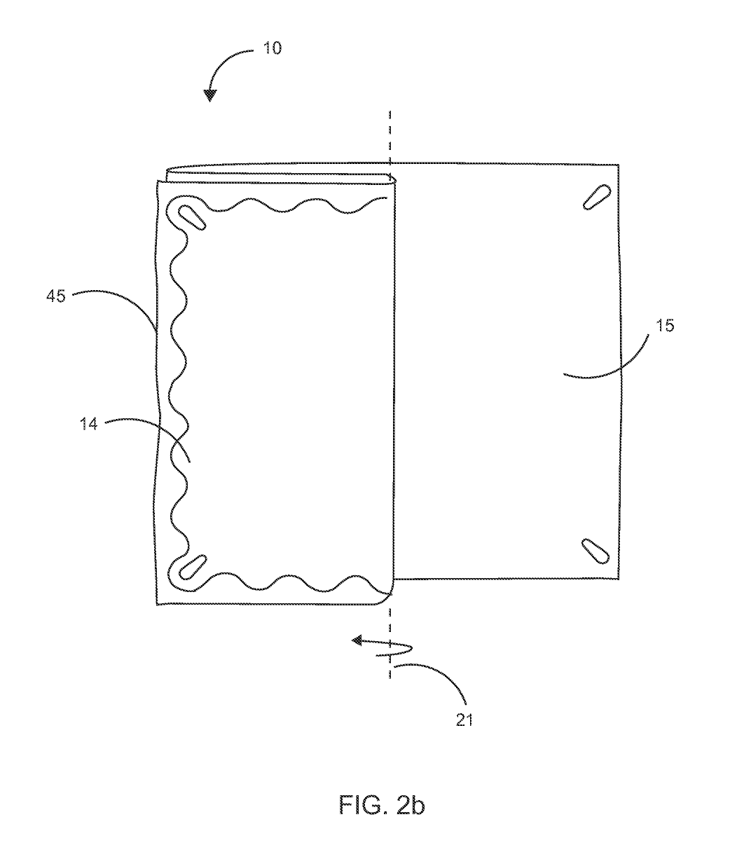

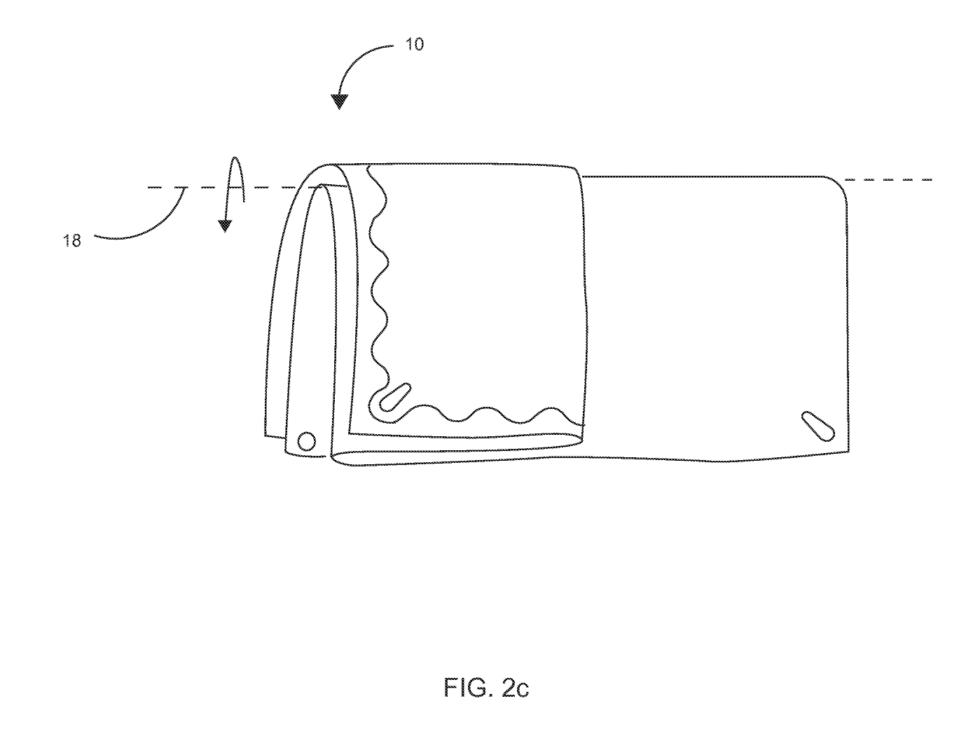

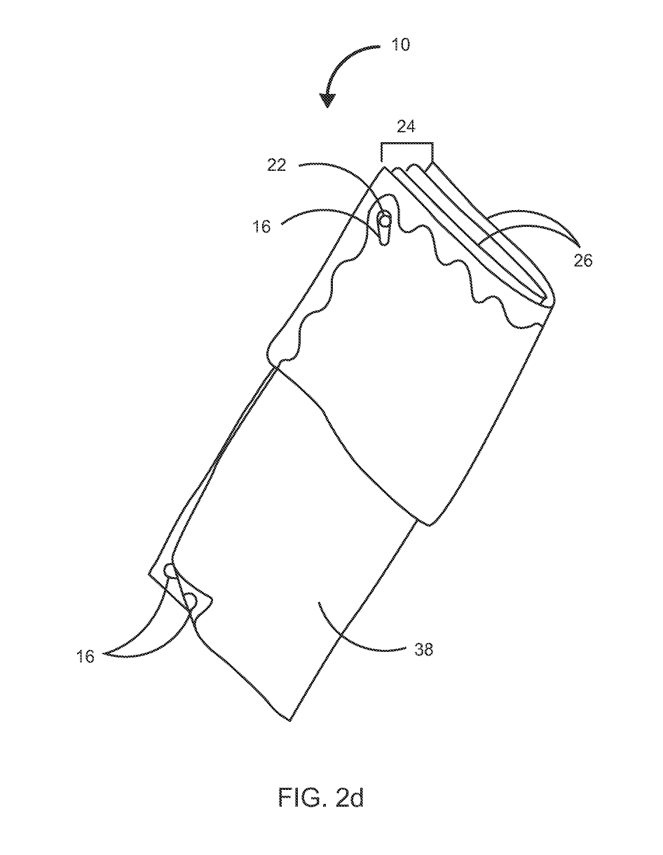

FIGS. 2a to 2d show a sequence of folding involved in the golf towel 10 for defining at least one water retaining pocket like structure by a double square type folding method. The method includes, placing the golf towel 10 with the wet surface 12 forms the right half of the forepart and the dry surface 14 and the dry surface 15 form the rear part. FIG. 2a shows the folding of the golf towel 10 along the central vertical axis 20 providing the wet surface 12 forms the forepart and forming the first flap 45 and the second flap 47. FIG. 2b represents the folding the first flap 45 of the golf towel 10 along the central vertical axis 21 providing the dry surface 14 at the forepart of the golf towel and the dry surface 15 at the rear part. FIG. 2c shows the folding of golf towel 10 along the centre across width 18 and the FIG. 2d shows the hanging of the golf towel 10 by means of the plurality of eyelets 16 and the connecting means 22 attached to the corners of the towel 24 thereby forming at least one water retaining pocket like structure 26. The double square type folding method provides a dry area 38 for cleaning purpose.

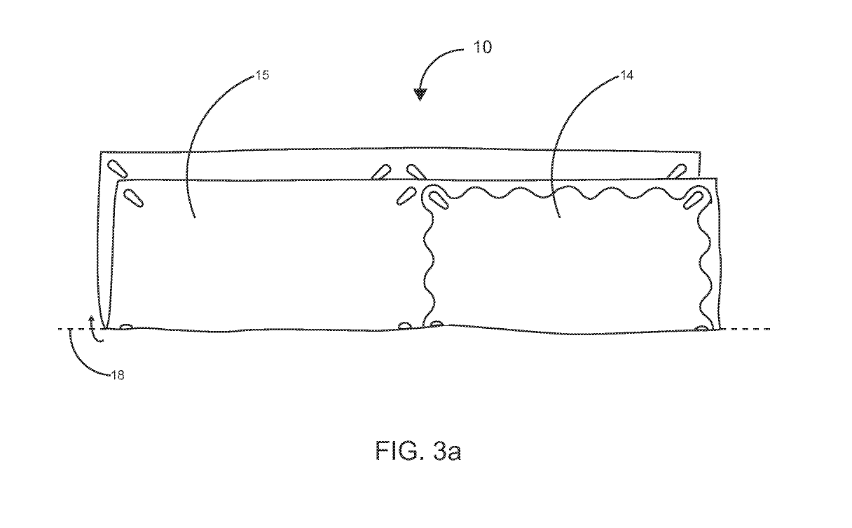

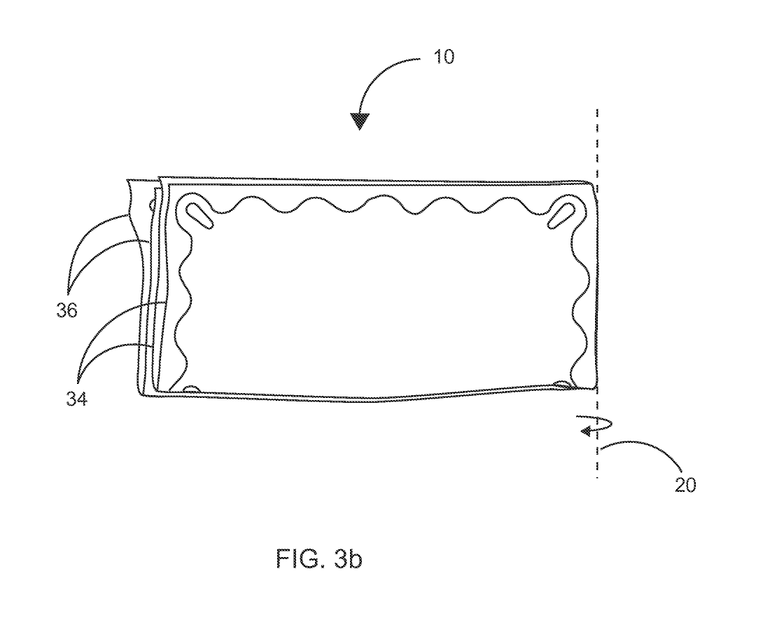

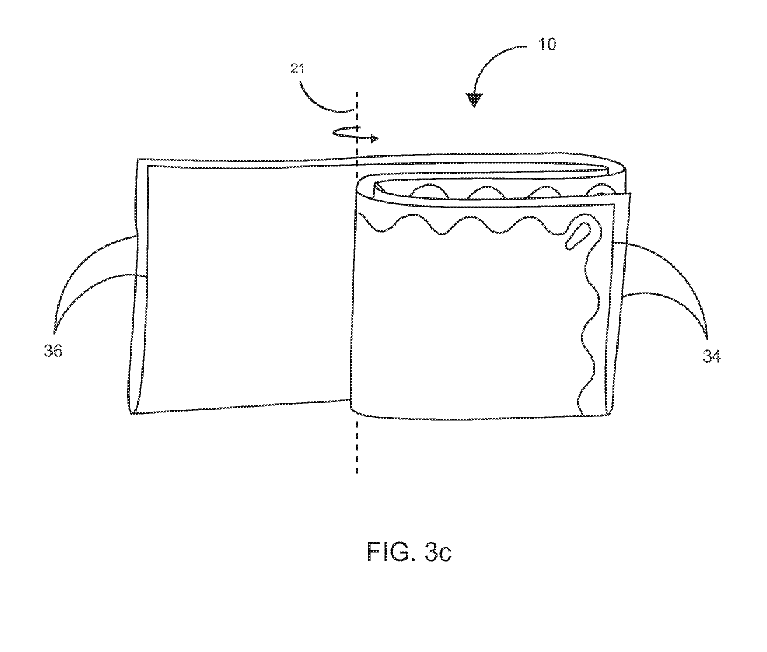

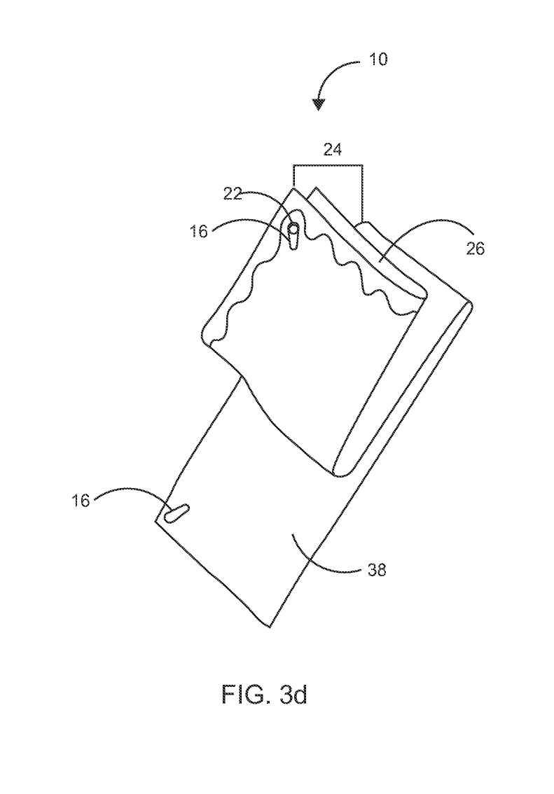

FIGS. 3a to 3d show a method of folding involved in the golf towel 10 for defining at least one water retaining pocket like structure by a rectangle type folding method. The method defines placing the golf towel 10 where the wet surface 12 to the right half of the forepart and the dry surface 14 and dry surface 15 form the rear part. FIG. 3a shows the folding of the golf towel 10 along the centre across width 18 where the dry surface 14 and dry surface 15 form the forepart. FIG. 3b represents the folding of the golf towel 10 along the central vertical axis 20 to form a pair of first flaps 34 and a pair of second flaps 36. FIG. 3c represents folding the pair of first flaps 34 along the central vertical axis 21 leaving the dry surface 14 at the forepart of the golf towel 10. Finally in the sequence, FIG. 3d shows the hanging of the golf towel 10 by means of the plurality of eyelets 16 and the connecting means 22 attached to the corners of the towel 24 thereby forming at least one water retaining pocket like structure 26. In addition, the rectangle type folding method provides the dry area 38 for cleaning purpose.

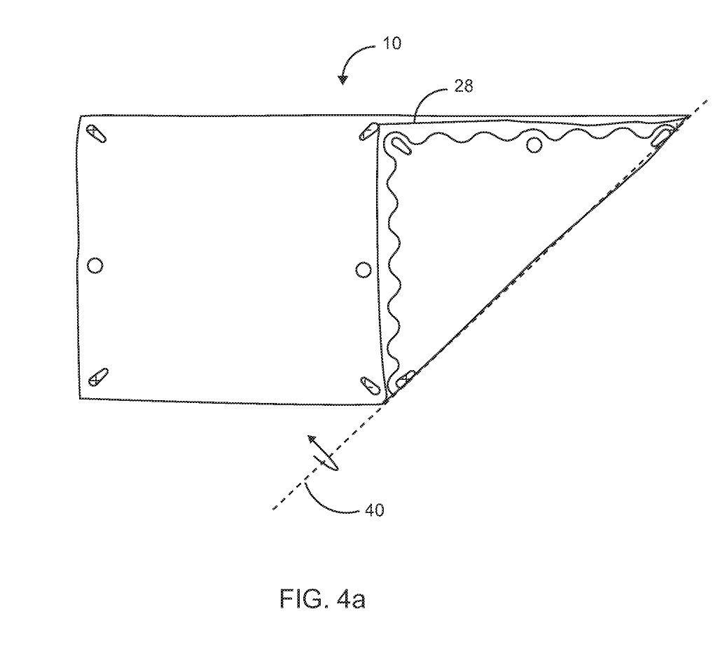

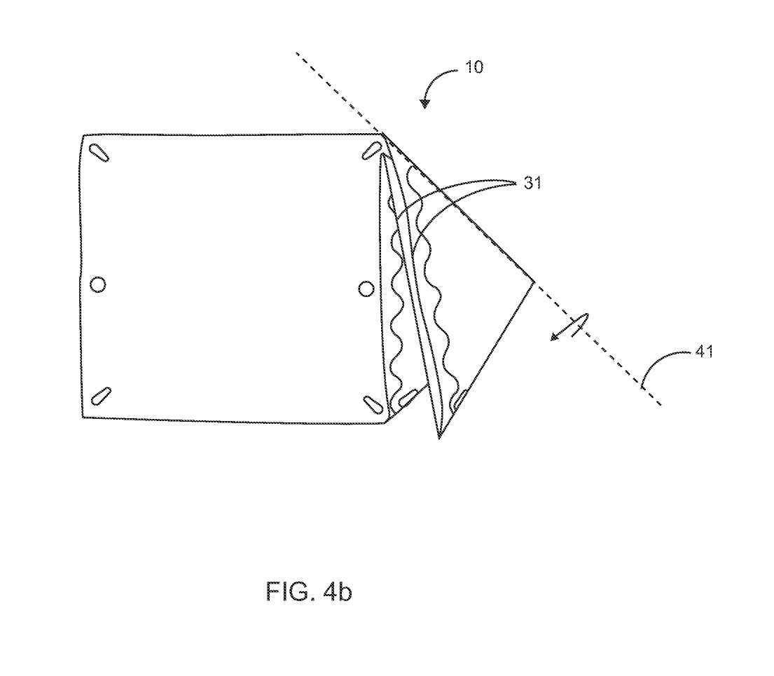

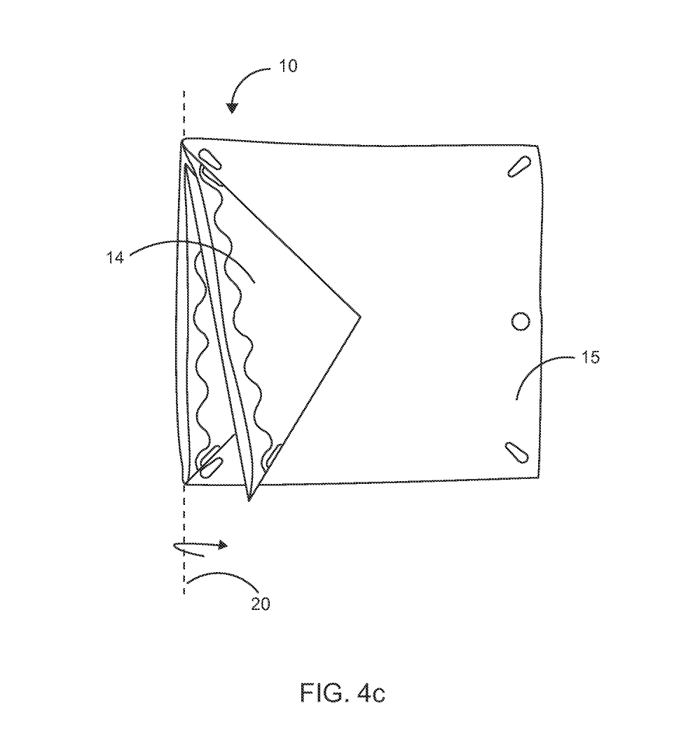

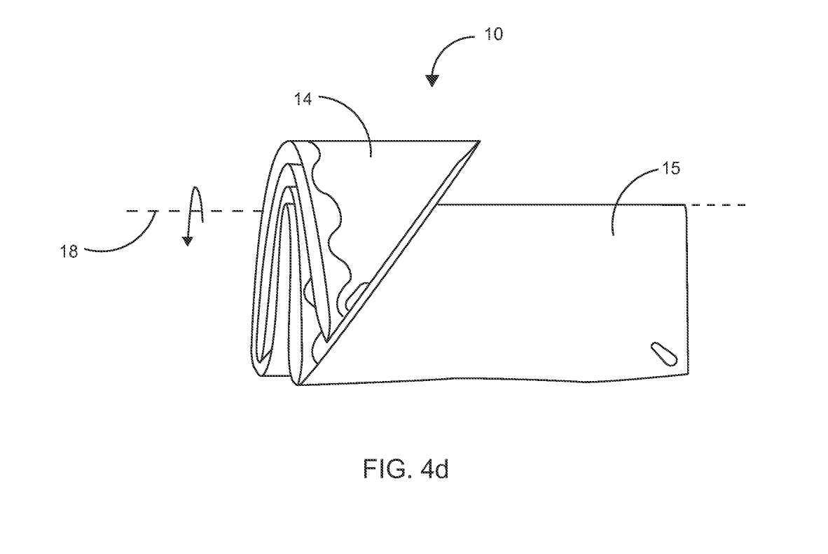

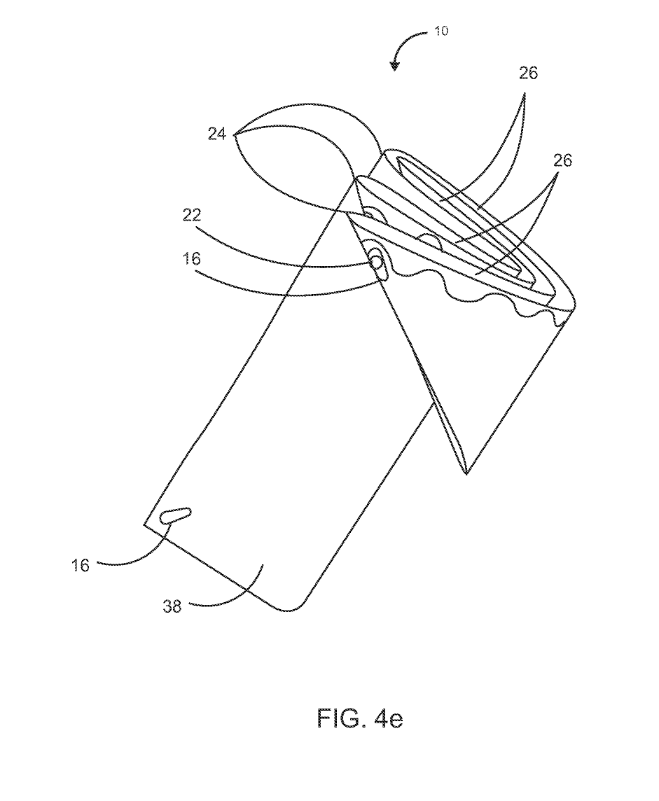

FIGS. 4a to 4e show a sequence of folding involved in the golf towel 10 for defining at least one water retaining pocket like structure by a double triangle type folding method. The method includes placing the golf towel 10 where the wet surface 12 forms the right half of the forepart and the dry surface 14 and the dry surface 15 form the rear part. FIG. 4a shows the folding of the golf towel 10 along the right central diagonal axis 40 to form a first flap 28. FIG. 4b represents the folding along the right central perpendicular diagonal axis 41 to form the pair of flaps 31 at the forepart of the golf towel 10. FIG. 4c shows the folding of the golf towel 10 reversely along the central vertical axis 20 leaving the dry surface 14 at the forepart and the dry surface 15 at the rear part of the golf towel 10. FIG. 4d show the folding of the golf towel 10 along the centre across width 18 where the dry surface 14 and the dry surface 15 form the forepart and the FIG. 4e shows the is hanging of the golf towel 10 by means of the plurality of eyelets 16 and the connecting means 22 attached to the corners of the towel 24 thereby forming at least one water retaining pocket like structure 26. The double triangle type folding method provides a dry area 38 for cleaning purpose.

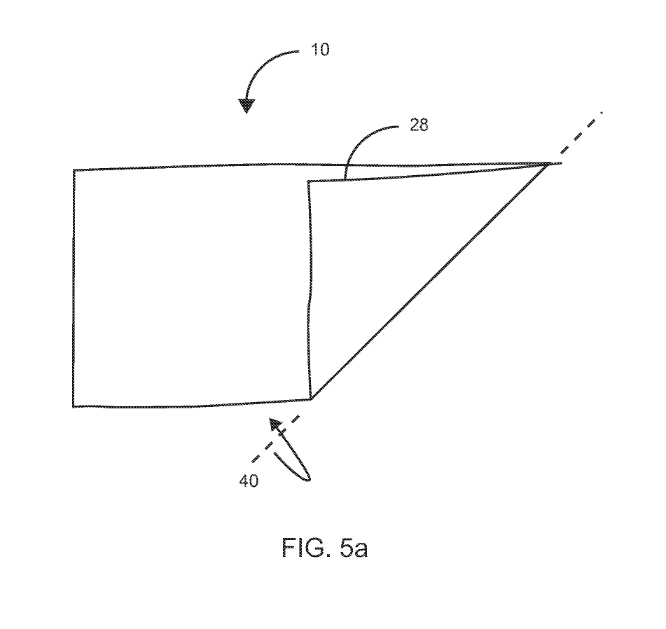

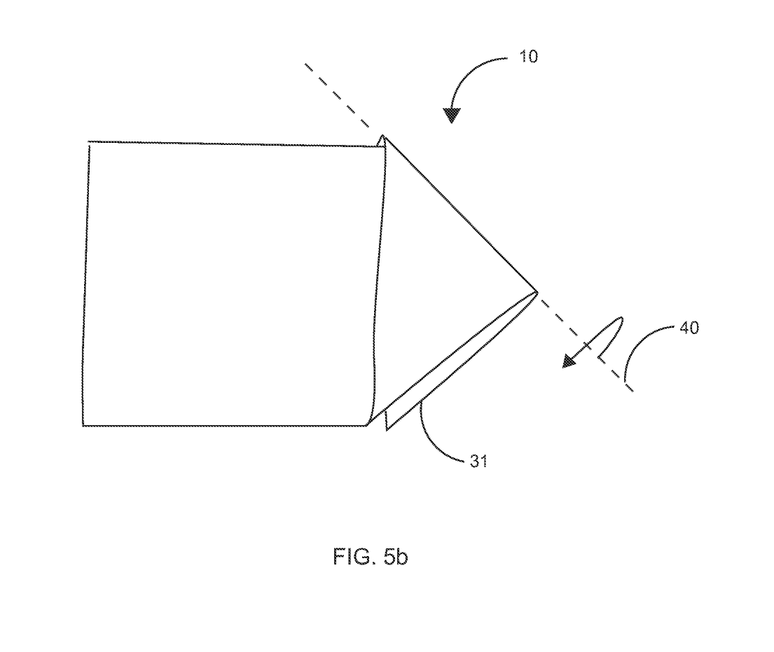

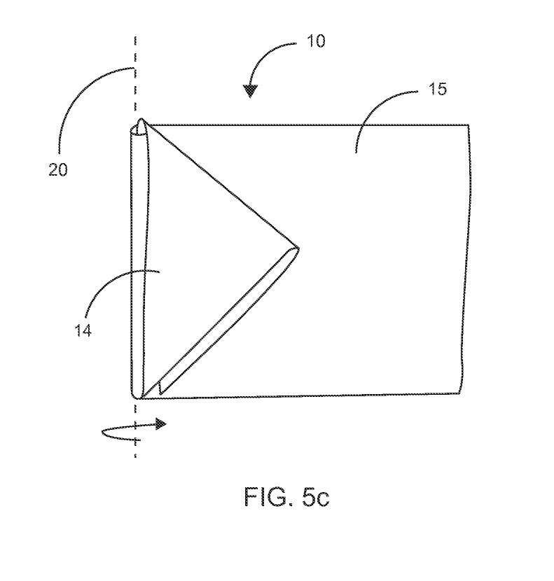

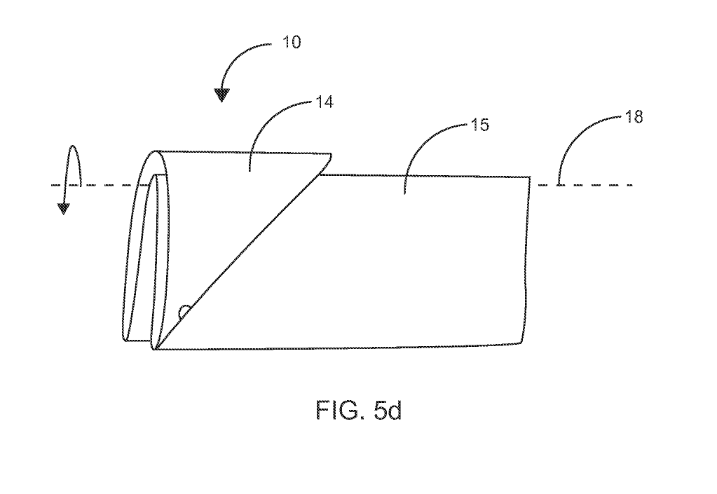

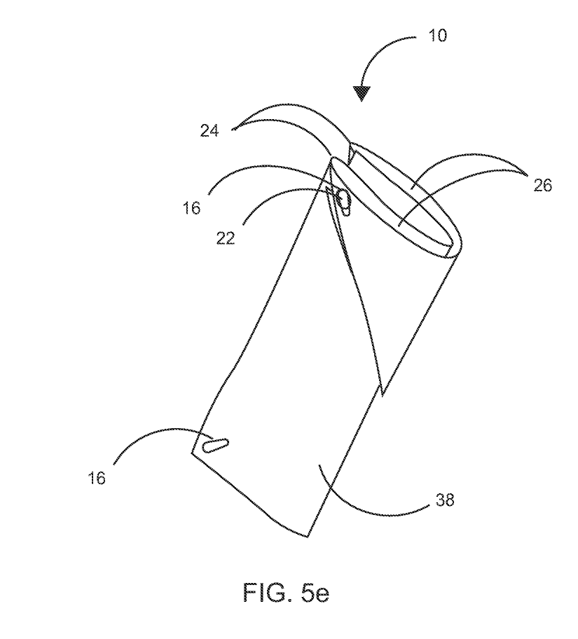

FIGS. 5a to 5e show a sequence of folding involved in the golf towel 10 for defining at least one water retaining pocket like structure by a triangle type folding method. The method includes placing the golf towel 10 where the wet surface 12 forms the right half of the forepart and the dry surface 14 and the dry surface 15 form the rear part. FIG. 5a shows the folding of the golf towel 10 along the right central diagonal axis 40 to form a first flap 28. FIG. 5b shows the folding reversely along the right central perpendicular diagonal axis 41 to form the double flap 31 at the rear part of the golf towel 10. FIG. 5c shows the folding of the golf towel 10 along the central vertical axis 20 leaving the dry surface 14 at the forepart and the dry surface 15 at the rear part of the golf towel 10. FIG. 5d show the folding of the golf towel 10 along the centre across width 18 where the dry surface 14 and the dry surface 15 form the forepart and the FIG. 5e shows the hanging of the golf towel 10 by means of the plurality of eyelets 16 and the connecting means 22 attached to the corners of the towel 24 thereby forming at least one water retaining pocket like structure 26. The triangle type folding method provides a dry area 38 for cleaning purpose.

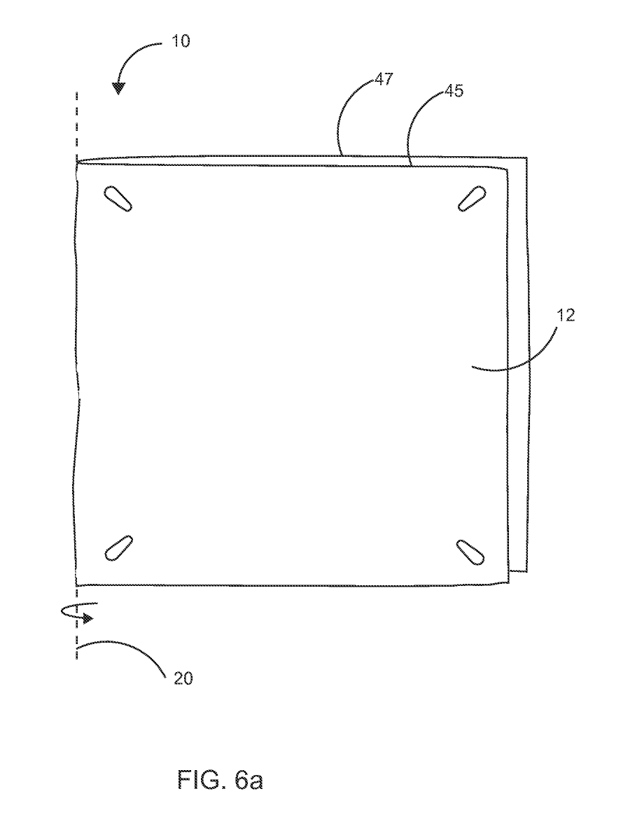

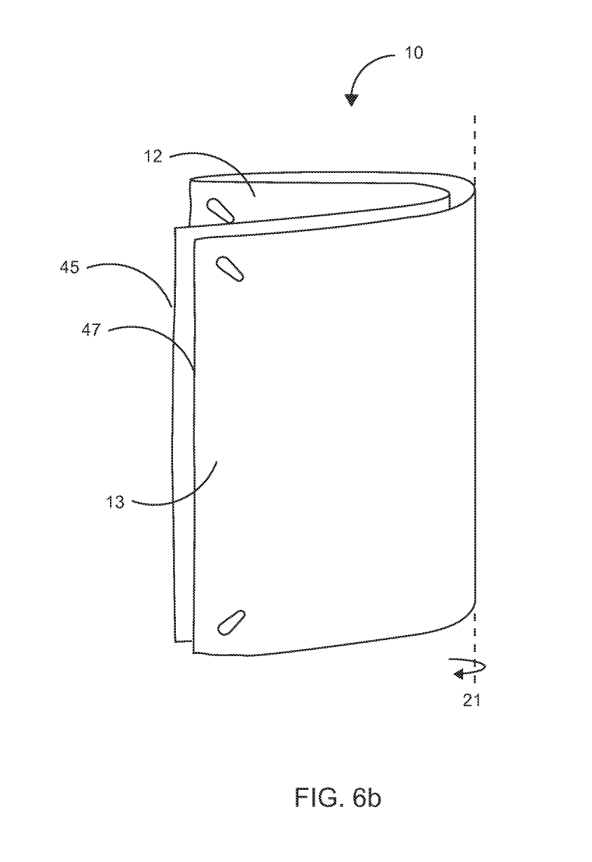

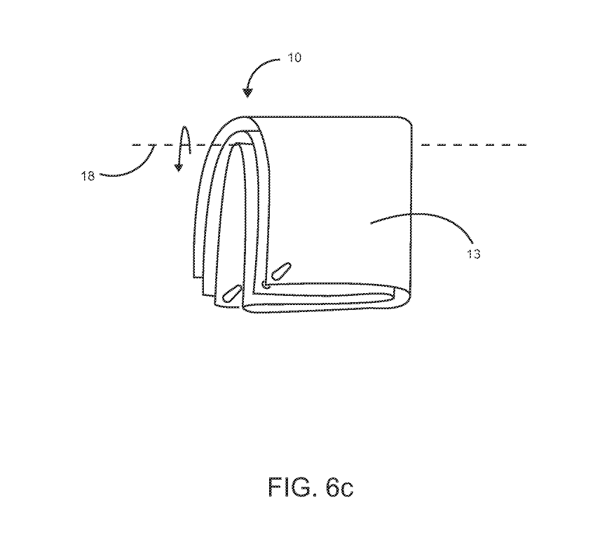

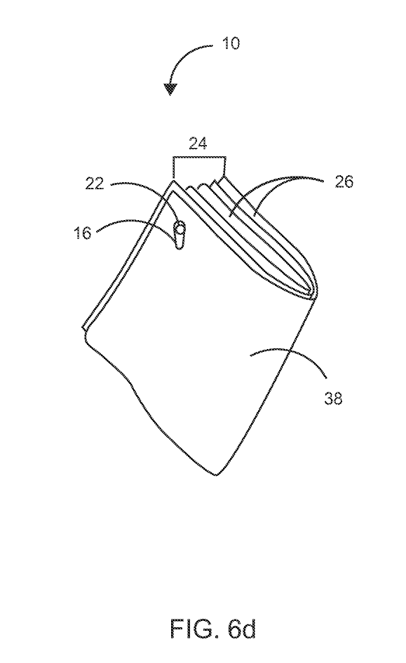

FIGS. 6a to 6d show a sequence of folding involved in the golf towel 10 for defining at least one water retaining pocket like structure by an inner double square type folding method. The method includes, placing the golf towel 10 with the wet surface 12 at the right of the forepart and the dry surface 14 and the dry surface 15 form the rear part. FIG. 6a shows the folding of the golf towel 10 along the central vertical axis 20 leaving the wet surface 12 at the forepart and the second flap 47. FIG. 6b represents the folding of the first flap 45 and the second flap 47 of the golf towel 10 along the central vertical axis 21 providing the dry surface 13 at the forepart and forming of the inner layer wet surface of 12. FIG. 6c shows folding the golf towel 10 along the width 18 providing the dry surface 13 and the FIG. 6d shows the hanging of the golf towel 10 by means of the plurality of eyelets 16 and the connecting means 22 attached to the corners of the towel 24 thereby forming at least one water retaining pocket like structure 26. The inner double square type folding method provides a dry area 38 for cleaning purpose.

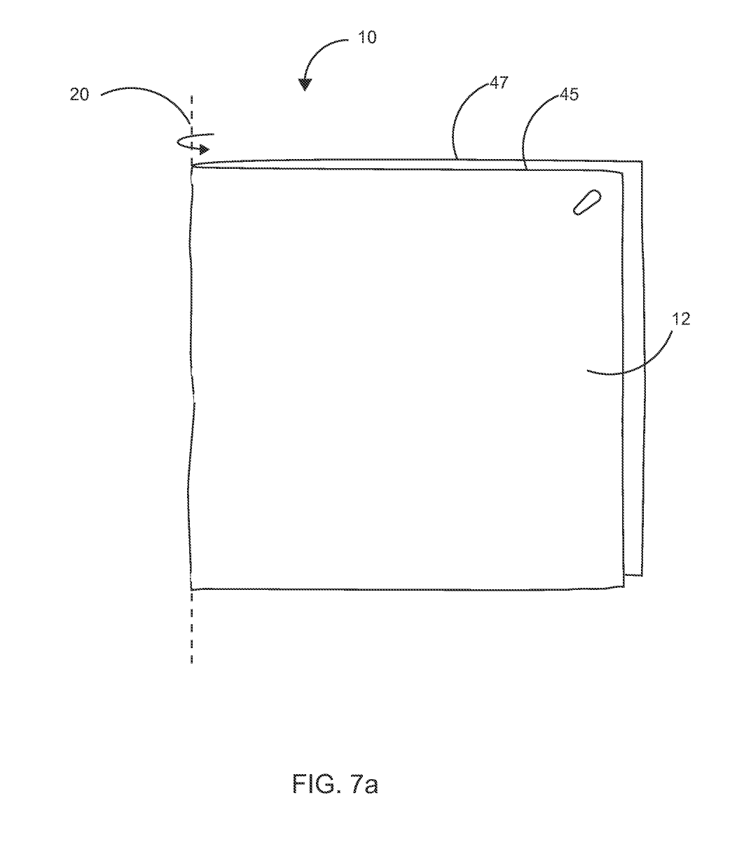

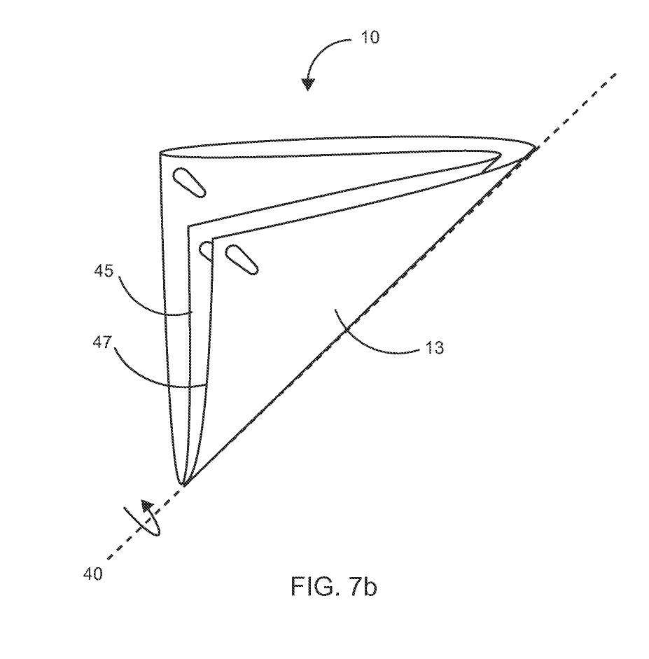

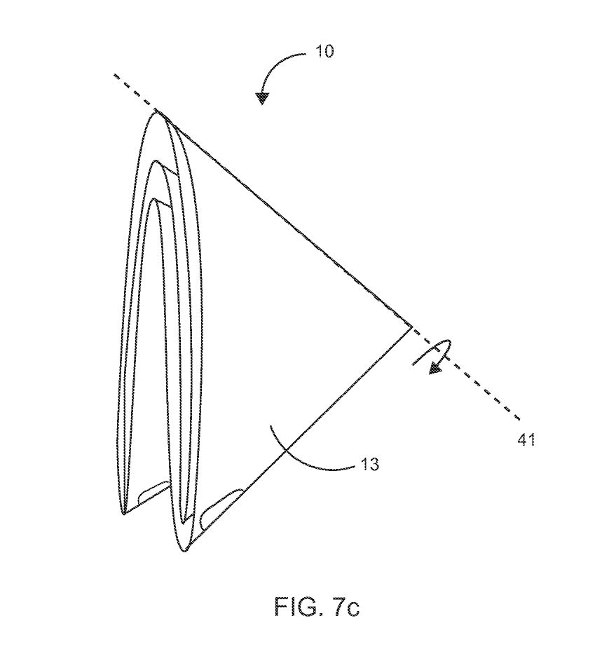

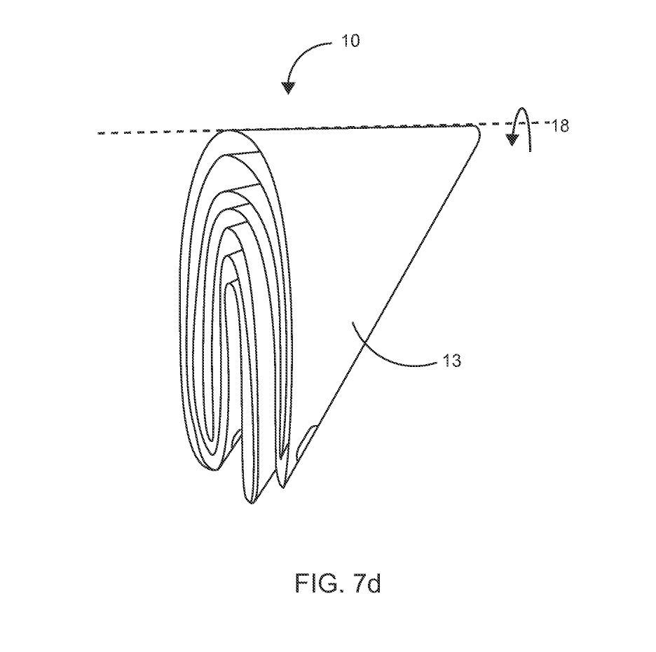

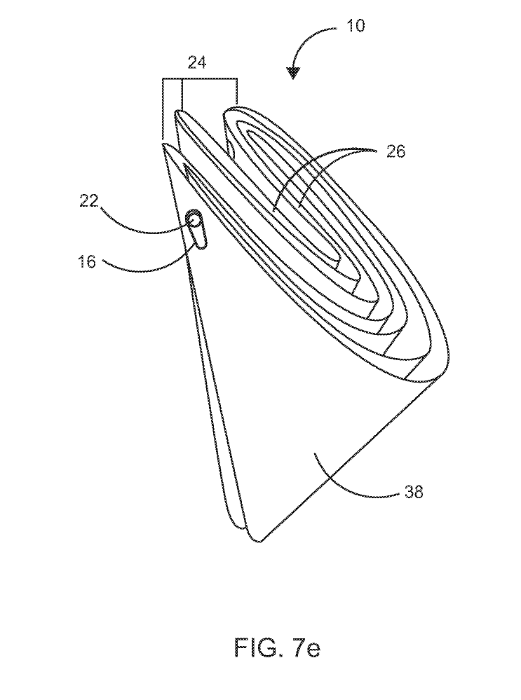

FIGS. 7a to 7e show a sequence of folding involved in the golf towel 10 for defining at least one water retaining pocket like structure by an inner double triangle type folding method. The method includes placing the golf towel 10 where the wet surface 12 forms the right half of the forepart and the dry surface 14 and the dry surface 15 form the rear part. FIG. 7a shows the folding of the golf towel 10 along the central vertical axis 20 leaving the wet surface 12 at the forepart and forms the first flap 45 and the second flap 47. FIG. 7b shows the folding of the golf towel 10 along the central diagonal axis 40 to form the first flap 47 and the second flap 45 and to leave the dry surface 13 at the forepart. FIG. 7c represents the folding along the central perpendicular diagonal axis 41 providing the dry surface 13 at the forepart of the golf towel 10. FIG. 7d shows the folding of the golf towel 10 along the centre across width 18 leaving the dry surface 13 at is the forepart of the golf towel 10. Finally in the sequence, FIG. 7e shows the hanging of the golf towel 10 by means of the plurality of eyelets 16 and the connecting means 22 attached to the corners of the towel 24 thereby forming at least one water retaining pocket like structure 26. The inner double triangle type folding method provides a dry area 38 for cleaning purpose.

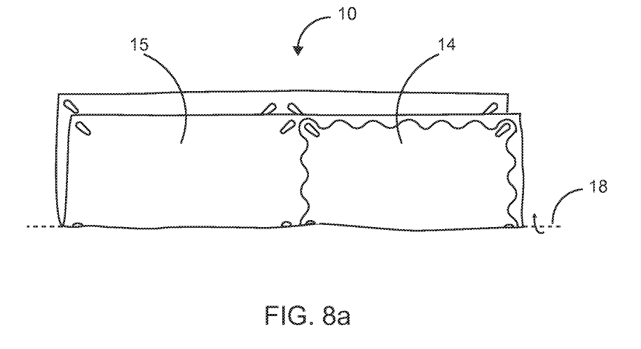

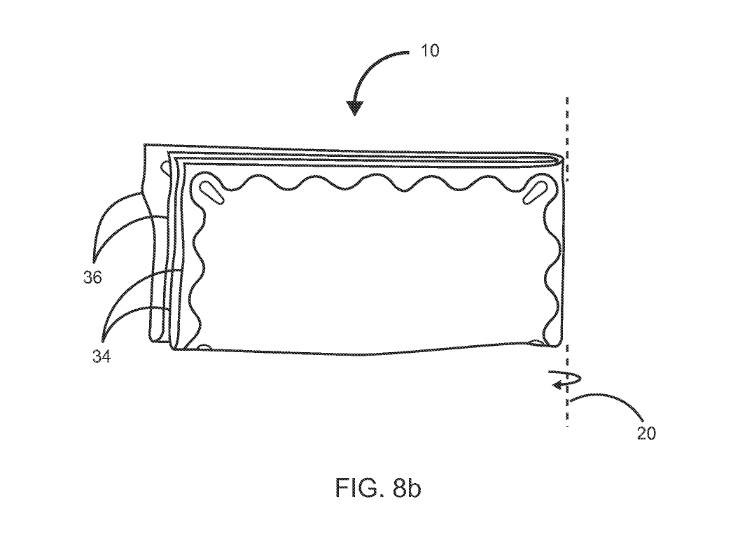

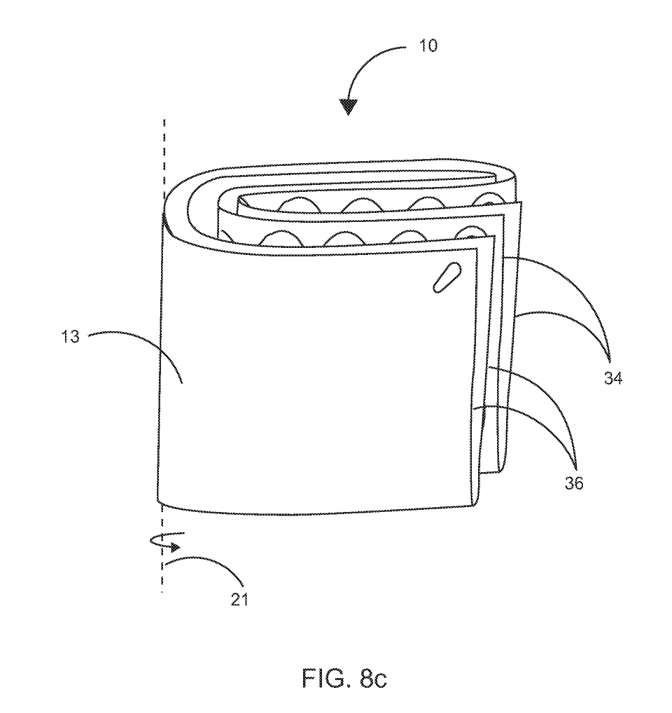

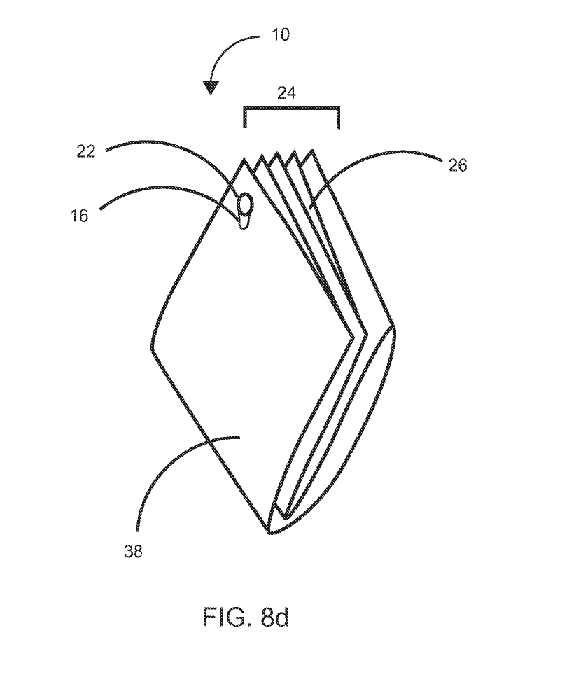

FIGS. 8a to 8d show a method of folding involved in the golf towel 10 for defining at least one water retaining pocket like structure by an inner rectangle type folding method. The method defines placing the golf towel 10 where the wet surface 12 forms the right half of the forepart and the dry surface 14 and dry surface 15 form the rear part. FIG. 8a shows the folding of the golf towel 10 along the centre across width 18 where the dry surface 14 and dry surface 15 form the forepart. FIG. 8b represents the folding of the golf towel 10 along the central vertical axis 20 to form a pair of first flaps 34 and a pair of second flaps 36. FIG. 8c represents folding the pair of first flaps 34 and the pair of second flaps 36 along the central vertical axis 21 leaving the dry surface 13 at the forepart of the golf towel 10. Finally in the sequence, FIG. 8d shows the hanging of the golf towel 10 by means of the plurality of eyelets 16 and the connecting means 22 attached to the corners of the towel 24 thereby forming at least one water retaining pocket like structure 26. In addition, the inner rectangle type folding method provides the dry area 38 for cleaning purpose.

While a particular form of the golf towel and methods of folding has been illustrated and described, it will be apparent that various modifications can be made without departing is from the spirit and scope of the invention. For example, materials, methods, structures and the like that will fall within the scope of the invention. It should be clearly understood that other golf towel and folding methods are also possible. Accordingly, it is not intended that the invention be limited, except as by the appended claims.

What is claimed is:

1. A golf towel for keeping at least one golf ball wet, comprising:
a wet surface and a number of dry surfaces, the wet surface and the dry surfaces being attached by means of plurality of eyelets and the connecting means using a water impervious layer;
whereby the golf towel can be folded in a number of ways defining at least one water retaining pocket like structure, the golf towel being folded bring forth a pressure along a folded edge to reduce the water evaporating from the wet surface.

2. The golf towel of claim 1 wherein the water impervious layer interposed between the wet surface and the dry surfaces prevents transferring of moisture from the wet surface to is the dry surface.

3. The golf towel of claim 1 wherein the water impervious layer may be made of polyurethane.

4. The golf towel of claim 1 wherein the pressure exerted at the folded edge will be greater as the number of folding in the golf towel increases, thereby minimizing the level of evaporation.

5. The golf towel of claim 1 wherein the wet surface and the dry surfaces may be made of microfiber.

6. The golf towel of claim 1 wherein the golf towel is narrower along the parallel edges from a middle portion of the wet surface to an edge of the golf towel.

7. The golf towel of claim 1 wherein the golf towel may contain a plurality of eyelets to hang the towel by using a connecting means.

8. A method of folding a golf towel for defining at least one water retaining pocket like structure by a double square type folding method, the method comprising:
a) placing the golf towel where a wet surface forms a right half of the forepart and the dry surfaces form a rear part;
b) folding of a golf towel along the central vertical axis to form a first wet is flap at the forepart and a second flap in the rear part;
c) folding a first flap of the golf towel along a central vertical axis where the dry surface forms the forepart:
d) folding the golf towel along the center across width; and
e) hanging the golf towel by means of a plurality of eyelets and a connecting means attached to the corners of the towel thereby providing a dry area for cleaning purpose.

9. The method of claim 8 wherein the water retaining pocket like structure being utilized to keep the golf ball wet.

10. A method of folding a golf towel for defining at least one water retaining pocket like structure by a rectangle type folding method, the method comprising:
a) placing the golf towel where a wet surface forms a right half of the forepart and the dry surfaces form a rear part;
b) folding the golf towel along a centre across width to form a first flap and a second flap;
c) folding the golf towel along the central vertical axis forming a pair of flaps a forepart and a pair of dry surface flaps a rear part;
d) folding the golf towel of the first pair of flaps along a central vertical axis providing the dry surface at the forepart of the golf towel;
e) hanging the golf towel by means of a plurality of eyelets and a is connecting means attached to the corners of the towel thereby providing a dry area for cleaning purpose.

11. The method of claim 10 wherein the water retaining pocket like structure being utilized to keep the golf ball wet.
